(19) United States
(12) Patent Application Publication
(10) Pub. No.: US 2008/0263581 A1
(43) Pub. Date: Oct. 23, 2008

(54) RECORDED COMMERCIAL OPTIMIZATION METHOD AND SYSTEM

(76) Inventor: Gary Turner, Parker, CO (US)

Correspondence Address: SHERIDAN ROSS PC, 1560 BROADWAY, SUITE 1200, DENVER, CO, 80202, US

(21) Appl. No.: 11/737,550

(22) Filed: Apr. 19, 2007

(51) Int. Cl. H04N 7/16

(52) U.S. Cl. 725/22

(57) ABSTRACT

Methods, and apparatuses for optimizing advertisements for an end user during are provided. More specifically, a Television signal may be broadcast to the end user with commercial segments inserted therein. The commercial segments may be transmitted with meta tags that identify information related to the commercial segment. Data from the meta tag for a commercial segment may be compared to local parameters associated with the end user to identify a commercial that should be played during the commercial segment.

### FIELD

The present invention is directed to interactive medias and more specifically methods, apparatuses, and systems for optimizing commercials presented during a broadcast commercial segment.

### BACKGROUND

Television (TV) has traditionally been used as a one-way communication medium in which the television network decides what programs will be shown at what times. Even with these restrictions TV has proven to be the worlds most popular media delivery device. However, due to certain limitations, TV technology has not been cultivated to the extent that Personal Computer (PC) technology has. More specifically, although TV advertising is a multi-billion dollar industry, many TV advertisements go unwatched or un-noticed. In fact, some companies will spend millions of dollars on a single ad campaign, but still cannot be sure how many people have watched their commercial. TV commercials to date are targeted toward a general audience. Most commercial segments are filled based on the content of the TV program that is broadcast with the commercial segment. For example, a televised sporting event may have its commercial segments filled with commercials directed toward a demographic that tends to watch such sporting events, whereas a cooking program may have its commercial segments filled with commercials directed toward a demographic that is assumed to watch cooking. This allows advertisers to target their advertisements to a certain degree as they try to maximize their revenue from commercials.

Unfortunately, the assumption that a specific target audience is watching a commercial segment during a program may be a false assumption. For instance, some viewers of a program may be interested in a certain type of product whereas other viewers may be more interested in another type of product. Traditional commercial segments are not optimized for individual viewers of the same program.

Some attempts have been made to customize commercials for individual viewers of a program. For example, U.S. Patent Publication No. 2004/0172650 to Hawkins et al., the entire contents of which are hereby incorporated herein by reference, describes an opt-in based system for displaying targeted content to a viewer. Viewer profiles and content profiles are automatically generated from forms filled out by viewers and content providers. Then content that best matches a viewer profile is downloaded from a server and stored on the corresponding viewer's set top box. Although this particular publication selects content based on a viewer profile, the system proposed is slow since a selected program has to be downloaded before the commercial segment is played. Furthermore, the '650 publication does not contemplate optimizing commercials presented during a recorded program. Instead, a single commercial is selected once for presentation during a commercial segment and no further optimizations are performed.

As another example, U.S. Patent Publication No. 2002/0147984 to Tomsen et al., the entire contents of which are hereby incorporated herein by reference, describes an interactive television system that initiates unprompted, context-sensitive requests for supplemental content related a broadcast program. Although the '984 describes a method of presenting supplemental content to different viewers of the same program, it does not provide a way to optimize a commercial segment of either a live TV program or a recorded program.

In still another example, U.S. Patent Publication No. 2005/0015796 to Bruckner et al., the entire contents of which are hereby incorporated herein by reference, describes a system and method for managing interactive programs and commercial content associated therewith. More specifically, the '796 publication describes inserting interactive commercials into a commercial segment, which each individual viewer can interact with in a different way. Accordingly, a viewer is allowed to customize their viewing experience to a certain degree. However, there is no optimization of the interactive commercial initially presented to each viewer. Rather, the same interactive commercial is initially presented. Some viewers may find the commercial enticing and begin interacting with it, while other viewers may not be interested by the interactive commercial presented.

What is needed is an efficient way to optimize commercial content on a user-by-user basis. Additionally, there is a need for a way to continually optimize commercials for recorded programs.

### SUMMARY

The present invention is directed to solving these needs and other problems and disadvantages of the prior art. In accordance with certain embodiments of the present invention, a method for optimizing commercial segments in a broadcast TV program is provided. One method embodiment of the present invention comprising:

receiving a program comprising at least one commercial segment, wherein the at least one commercial segment has a meta tag associated therewith;

analyzing data from the meta tag;

determining optimization parameters for the at least one commercial segment;

comparing the optimization parameters to parameters of commercials from a set of locally available commercials;

determining that parameters of a first commercial meet the optimization parameters as well as or better than parameters of other commercials in the set of locally available commercials; and

selecting the first commercial for presentation during the at least one commercial segment.

As used herein a “meta tag” is understood to include any type of data structure used to carry a descriptor element for another data structure. Various types of meta tags known in the art may be used to provide structured metadata or other descriptive data about a commercial or similar type of programming content. In accordance with at least some embodiments of the present invention, a meta tag may be inserted within a header of a packet transmitted across a broadcast system.

The optimization of the program may occur either during the real-time presentation of the program or for the presentation of a recorded program. In accordance with at least one embodiment of the present invention, a recorded program may be optimized more than one time. More specifically, whenever a new commercial is downloaded by a Set Top Box (STB), an optimization decision may be made regarding whether the new commercial should be prepared for presentation during the recorded program. Accordingly, it is one inventive aspect of the present invention to provide a recorded program that may present a plurality of different commercials during different play back times of the same commercial segment. More specifically, a first commercial may be presented during a first presentation of the commercial segment and a second different commercial is presented during a second later presentation of the same commercial segment.

In accordance with certain embodiments of the present invention, an apparatus for optimizing commercial segments in a broadcast TV program is provided. One apparatus embodiment of the present invention comprising:

a receiver adapted to receive broadcast signals from a transmission network, wherein the broadcast signals comprise data related a program having at least one commercial segment with a meta tag associated therewith;

a plurality of locally available commercials; and

a commercial optimization agent adapted to select a first commercial from the plurality of locally available commercials for presentation during the at least one commercial segment, wherein the first commercial comprises characteristics that meet parameters of the meta tag better than other commercials in the plurality of locally available commercials.

It is another aspect of the present invention to optimize a commercial segment based on commercials that are locally available for presentation during a commercial segment. In accordance with at least one embodiment of the present invention, a locally available commercial is an audio, video, still image, or other type of commercial that is presently available on a local storage medium for presentation during a commercial segment. In one embodiment, the locally available commercial is stored on memory of a local STB prior to the STB receiving the program. When the commercial is optimized for the viewer associated with the STB, a locally available commercial may be selected in order to minimize the amount of time required to prepare the commercial for presentation during the commercial segment. More specifically, the optimization may not need to account for the amount of time it will take to download the subject commercial from a broadcast head end. Certain embodiments of the present invention, however, account for the amount of time required to download a selected commercial when optimizing a particular commercial segment or a program in general.

It is another aspect of the present invention to globally optimize a given program as well as specifically optimize each commercial segment within the program. In accordance with one embodiment of the present invention, a meta tag may be associated with individual commercial segments, also known as commercial sub-segments. Such a meta tag may be analyzed to determine which particular commercial would best suit the subject sub-segment. Additional meta tags may be associated with an entire commercial break (e.g., a collection of commercial sub-segments) and/or an entire program. These particular meta tags may define other restrictions and preferences related to the overall assignment of commercials to commercial segments in the program or break.

In accordance with one embodiment of the present invention, optimization parameters may be determined based on the comparison of data from meta tags associated with a program against local parameters. The optimization parameters may yield decision weights that can be applied to various commercials in order to select the best commercial for optimization of the commercial segments as well as the overall program. More specifically, optimization parameters are determined on a STB by STB basis and furthermore on a viewer-by-viewer basis. Accordingly, optimization parameters for one viewer may not necessarily be the same as optimization parameters for another viewer. This enables the optimization of a single program for a number of different viewers.

The broadcast of a TV signal generally corresponds to the point in time when the program is broadcast across a transmission network and received at the STB. In one embodiment, the broadcast time corresponds to the time when a program may be viewed live or when the program is first aired for public viewing. In an alternative embodiment, the broadcast time may correspond to a point in time when a program is recorded.

In accordance with one embodiment of the present invention, the chosen commercial presented during a commercial segment may correspond to interactive content, such as an interactive advertisement. Examples of both long and short-form interactive advertisements and other interactive TV media are described in U.S. patent application Ser. No. 11/425,652 filed Jun. 21, 2006, U.S. patent application Ser. No. 11/552,047 filed Oct. 23, 2006, and U.S. patent application Ser. No. 11/622,426 filed Jan. 11, 2007, all of which are hereby incorporated by reference in their entirety. In one embodiment, a user engages the interactive advertisements through the use of “triggers” transmitted along with broadcast data. The insertion of triggers into a broadcast stream is known in the art. Program content in which such triggers have been inserted is sometimes referred to as enhanced program content or as an enhanced TV program or video signal. However, “enhanced content” as used herein is not limited to interactive TV media, but may incorporate any other type of user-perceivable media including, without limitation, audio, video, and still images.

Triggers may be used to alert a STB that interactive content is available. The trigger may contain information about available enhanced content as well as the memory location of the enhanced content. A trigger may also contain user-perceptible text that is displayed on the screen, for example, at the bottom of the screen, which may prompt the user to perform some action or choose amongst a plurality of options. Thus, a user with a TV that has interactive functionality may be prompted at the beginning of an enhanced TV program to choose between interactive and passive (non-interactive) viewing of the enhanced TV program. If the user chooses passive viewing, any further triggers contained in the enhanced TV program may be ignored by the STB and the user will view the program in a conventional way. However, if the user chooses the interactive option, then further triggers may be embedded in the enhanced TV program.

Triggers may be inserted into the broadcast stream at various points along the broadcast path. Triggers may be inserted into the broadcast stream before broadcast of the content by a broadcast station or any other media provider. Thus, these triggers would be part of the broadcast stream received by cable head ends and further distributed to TVs within homes. TVs are provided with interactive functionality by their associated STBs.

One common method for inserting data such as triggers into an analog video signal is the placement of that data into the unused lines of the video signal that make up the vertical blanking interval (VBI). Closed caption text data is a well known example of the placement of data in the VBI of the video signal. The closed caption text data is typically transmitted during line 21 of either the odd or even field of the video frame in a National Television Standards Committee (NTSC) format. Closed caption decoders strip the encoded text data from the video signal, decode the text data, and reformat the data for display, concurrent with the video data, on a TV screen. Such closed caption decoders process the text data separately from the video signal.

The Advanced Television Enhancement Forum (ATVEF) has defined protocols for Hypertext Markup Language (HTML)-based enhanced TV. These protocols allow the delivery of enhanced TV programs to STBs and other devices providing interactive functionality by various transmission means, including, but not limited to, analog, digital, cable, and satellite. For the NTSC format, ATVEF specifies the type of information that may be inserted into the VBI of the video signal and on which lines of the VBI that information may be inserted. ATVEF specifies line 21 of the VBI as the line for insertion of an “ATVEF trigger,” i.e. the information that the STB or other device with interactive functionality interprets to provide interactive features to the enhanced TV program. ATVEF-A triggers comprise a Universal Resource Locator (URL), which provides an Internet address from which interactive content may be downloaded, whereas ATVEF-B triggers themselves can contain interactive content.

As used herein “content” or “multi-media” programs include any type of user-perceptible substance that can incorporate visual and/or audio media. Content is typically in the form of video media or static pages that can be viewed on a TV or the like by a user. Examples of content and multi-media programs include, but are not limited to, a live broadcast that may be received from a satellite provider, a cable provider, or over free air, advertisements or information for certain products and/or services, recorded images, computer rendered images or other graphics, audio content, and so on.

The summary is not intended to provide an exhaustive description of all embodiments of the present invention. Namely, additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting a broadcast and display system in accordance with embodiments of the present invention;

FIG. 2 is a block diagram depicting a STB and viewer control interface in accordance with embodiments of the present invention;

FIG. 3 is a block diagram depicting the data structure of a meta tag and local parameters in accordance with embodiments of the present invention;

FIG. 4 is a flow chart depicting a method of recording a program having meta tags associated therewith in accordance with embodiments of the present invention;

FIG. 5 is a flow chart depicting a method of optimizing a recorded program with a new commercial in accordance with embodiments of the present invention; and

FIG. 6 is a flow chart depicting a method of optimizing a commercial segment based on commercial scores in accordance with embodiments of the present invention.

### DETAILED DESCRIPTION

The exemplary embodiments of this invention will be described in relation to optimization of commercial segments, such as commercial segments stored on a Digital Video Recorder (DVR) or other type of Set Top Box (STB), such as those designed and distributed by TiVo®. However, it should be appreciated, that in general, the systems and methods of this invention will work equally well for any type of communication system and/or data storage system in any environment.

The exemplary systems and methods of this invention will also be described in relation to television broadcast systems and associated communication hardware, software and broadcast channels. However, to avoid unnecessarily obscuring the present invention, the following description omits well-known structures, network components and devices that may be shown in block diagram form, are well known or are otherwise summarized.

For purposes of explanation, numerous details are set forth in order to provide a thorough understanding of the present invention. It should be appreciated, however, that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a television broadcast network and/or the Internet, or within a dedicated secure, unsecured and/or encrypted system. Thus, it should be appreciated that the components of the system can be combined into one or more devices, such as a broadcast head end, or collocated on a particular node of a distributed network, such as an analog and/or digital broadcast network. As will be appreciated from the following description, and for reasons of computational efficiency, the components of the system can be arranged at any location within a distributed network without affecting the operation of the system. For example, the various components can be located in a broadcast head end server, at one or more users' premises, or some combination thereof. Similarly, one or more functional portions of the system could be distributed between a Set Top Box (STB), a display apparatus, and/or an associated computing device.

Embodiments of the present invention are generally directed toward methods and systems for administering commercials within a broadcast program and creating an optimization of such commercials for the benefit of each viewers experience. Although well suited for use with a television or similar type of display apparatus in conjunction with a STB, those skilled in the art can appreciated that embodiments of the present invention may also be implemented in conjunction with a simple television set not including a STB. Moreover, the systems and methods described in the present disclosure may be implemented in any media that may be enhanced through the use of events including, but not limited to, triggers that are synchronized to user-perceptible segments in a broadcast or other type of content.

As used herein “viewer” and “user” are used synonymously to refer to any person or thing that is currently making use of and/or interacting with the enhanced television system.

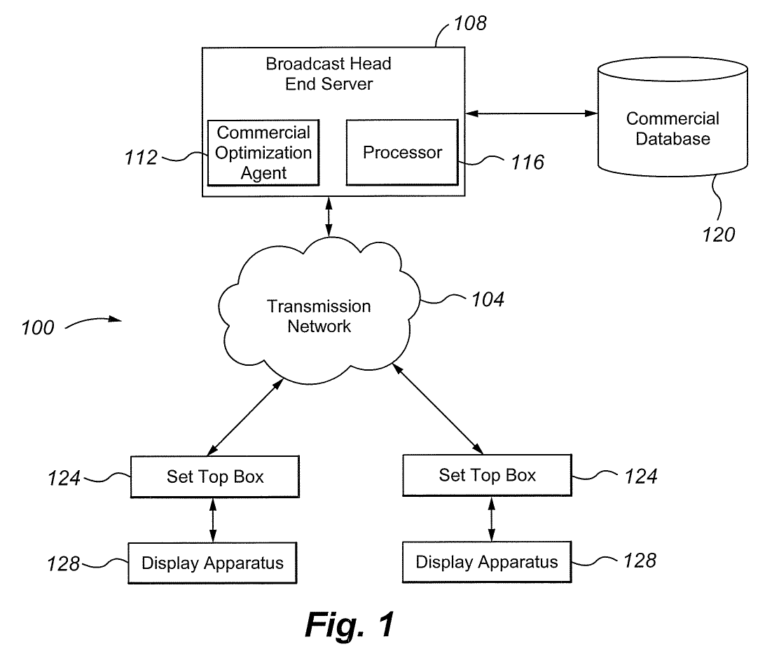

Referring now to FIG. 1, one embodiment of a broadcast system 100 will be described in accordance with embodiments of the present invention. The broadcast system 100 may comprise a transmission network 104, a broadcast head end server 108 including a commercial optimization agent 112 and a processor 116, a commercial database 120, a plurality of set top boxes (STBs) 124, and a plurality of display apparatuses 128. Each STB 124 and display apparatus 128 may generally comprise a TV system and although each display apparatus 128 is depicted with a corresponding STB 124, the display apparatus 128 may be directly connected to the transmission network 104, thereby obviating the need for a STB 124.

In accordance with one embodiment of the present invention, the transmission network 104 is characterized by a number of signal carrying and relaying devices. The transmission network 104 may comprise an over-air transmission network where a terrestrial transmitter transmits TV signals. Alternatively, or in addition, the transmission network 104 may comprise a satellite transmission network employing terrestrial based and satellite based signal transmitters. In a satellite transmission network, signals may be initially transmitted by a base terrestrial transmitter and may be relayed by satellites orbiting in the Earth's atmosphere to satellite receivers associated with users of the network 104. In such an embodiment, the satellite receiver is connected to the STB 124, which decodes the signal received at the satellite receiver.

Another type of transmission network 104 that may be employed is a cable network. A cable network may comprise an extensive network of cables (e.g., coaxial, fiber optic, etc.) that are used to carry signals from the broadcast head end server 108 to each network user. Any other type of known transmission network 104 may be employed in accordance with embodiments of the present invention.

The broadcast head end server 108, in accordance with one embodiment of the present invention, is characterized by the ability to process a number of different broadcast programs associated with a number of different broadcast stations for transmission across the transmission network 104. The broadcast head end server 108 may comprise a single server or a member of servers (i.e., a server pool) each having capabilities of the broadcast head end server 108 described herein. The term “server” as used herein should be understood to any type of dedicated processing resource such as a media server, a broadcast server, computers, adjuncts, etc.

The broadcast head end server 108 may receive broadcast feeds from a number of different sources, such as different broadcast stations. Within such broadcasts, the broadcast stations may incorporate a number of different commercials or commercial segments. Generally, the commercial segments are initially occupied by commercials targeted for a general viewing audience. Such general commercials may be inserted to the commercial segment at the broadcast station or source. Alternatively, some commercial segments may be dedicated to local commercials. Such local commercials may be inserted to the program at the broadcast head end server 108 or at another downstream router. Still further in the alternative, the broadcasts may be provided to a user by the broadcast head end server 108 in an on-demand fashion. When a user requests a particular program from a broadcast head end server 108, the server 108 may retrieve the program from an appropriate source and “broadcast” the program to the requesting user only through use of a buffer system between the broadcast head end server 108 and the appropriate STB 124.

The broadcast head end server 108 may be in communication with a commercial database 120, which generally represents a means for storing commercials. The commercial database 120 may be employed to store a number of different commercials of various lengths from a number of different companies. Commercials stored in the commercial database 120 may be provided by the broadcast head end server 108 as a part of optimizing commercial content for presentation with a program. The commercial optimization agent 112 may be employed by the processor 116 to select and insert such commercials into a broadcast signal for presentation of either a live program or a recorded program. The commercial optimization agent 112 may also contain instructions for monitoring the activity of display apparatuses 128 and/or STBs 124 to determine when a particular segment of interest in a program is being played.

The commercials stored in the commercial database 120 may include normal commercials used to update older commercials that have been recorded, short commercials, long commercials, customized commercials, and/or interactive commercials comprising triggers for facilitating user interaction with the commercial.

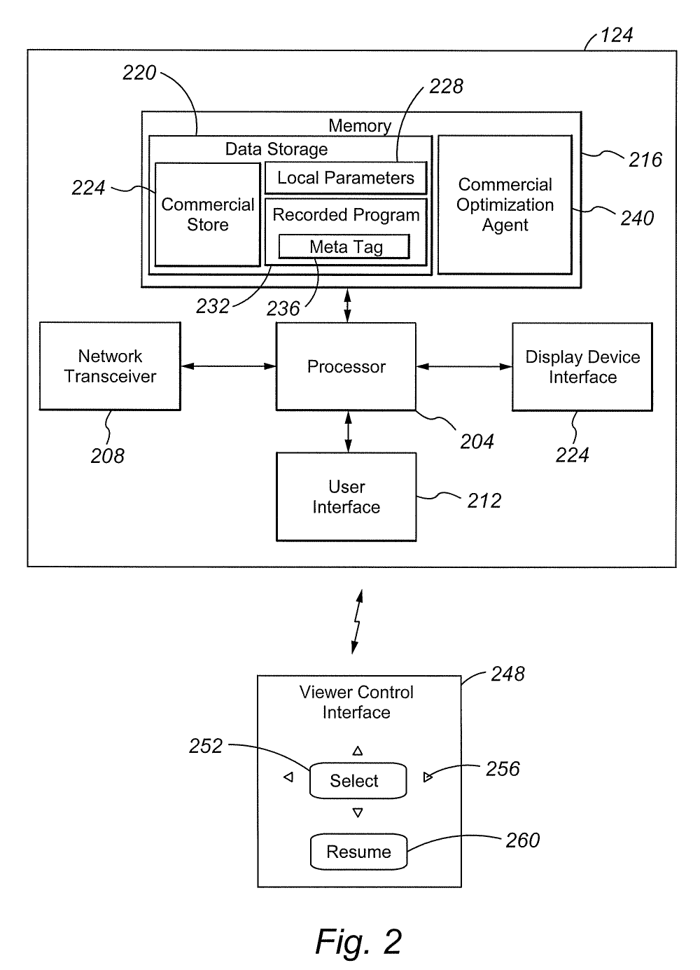

With reference now to FIG. 2, a STB 124 and viewer control interface 248 will be described in accordance with at least some embodiments of the present invention. The STB 124 may comprise a processor 204, a network transceiver 208, a user interface 212, memory 216 including data storage 220 and a commercial optimization agent 240, and a display apparatus interface 244.

The processor 204 may be implemented as a microprocessor or similar type of processing chip. The processor 204 may complete executable instructions or routines stored in a portion of memory 216. Alternatively, the processor 204 may be implemented in the form of an application specific integrated circuit (ASIC) that is operable to perform predefined functions based on predetermined inputs. The processor 204 generally functions to run programming code including operating system software, and one or more applications implementing various functions performed by the STB 124, and generally comprises a means for analyzing and selecting.

The memory 216, generally representing a means for storing and/or recording, may be implemented as a volatile or non-volatile memory, or combinations thereof. For example, the memory 216 may comprise a temporary or long-term storage of data or processor instructions. Such data and processor instructions may be stored in the data storage 220. The memory 216 may be used in connection with implementing an interactive application for presentation on the display apparatus 128. The memory 216 may comprise solid-state memory resident, removable or remote in nature, such as DRAM, SDRAM, ROM, and EEPROM.

The data storage 220 may further contain a commercial store 224, local parameters 228, and one or more recorded programs 232. The commercial store 224 may be employed to store various types of commercials such as, for example, interactive commercials, updated commercials, short commercials, still images, and the like for quick access and presentation of such content while a commercial segment is being played. The data storage 220 may include content similar to the type of content stored in the commercial database 120. The size of memory dedicated to the commercial store 224 may be limited such that only a fixed number of commercials can be maintained locally at once. Accordingly, commercials downloaded by the STB 124 from the broadcast head end server 108 may be personalized based on the user or users associated with the STB 124.

Advantageously, older commercials in the commercial store 224 may be updated and replaced by newer commercials upon initiation of such replacement either by the broadcast head end server 108 or the STB 124. In other words, the commercial optimization agent 240 associated with the STB 124 may decide that a certain commercial has expired and will therefore generate a request to download a new commercial from the broadcast head end server 108. Alternatively, the commercial optimization agent 112 associated with the broadcast head end server 108 may determine that a particular commercial is to be replaced with a new commercial and will therefore automatically transmit the new commercial to the STB 124 thereby replacing the older commercial.

The data storage 220 may also be used to maintain data associated with the STB 124, its user or users, and commercials stored thereon in the form of local parameters 228. The local parameters 228 may generally contain user parameters and memory parameters such as data related to the commercials stored in the commercial store 224. The user parameters may include both observed and user provided data. For instance, observed user parameters may comprise the zip code or location associated with the STB 124, user viewing history, and recording history. On the other hand, the user provided data might comprise personal information provided by the viewer via a survey or through interaction with interactive applications or commercials. More personalized data such as a user's interests, taste, hobbies, and so on may be included in the user provided data. Data related to each commercial such as the type of commercial, its length, and its target demographic may also be maintained in the commercial store 224 for analysis by the commercial optimization agent 112, 240.

A recorded program 232 may also be stored in the data storage 220. The program may have been broadcast with one or more meta tags 236 defining certain characteristics of commercial segments within the program. Such meta tags 236 may also be stored with the recorded program 232. During the presentation of a program and/or upon recording a particular program, the commercial optimization agent 240 may associate one or more commercials from the commercial store 224 with the program thereby creating a link between the commercial and the program. The commercial optimization agent 240 may choose the commercial to associate with the program based on the programs meta tags 236.

In accordance with one embodiment of the present invention, when the recorded program 232 is being replayed and it is determined that a commercial from the commercial store 224 should be presented to a user, the commercial may be retrieved from the local memory 216 rather than waiting to download the commercial from the broadcast head end server 108. This reduces the bandwidth utilization between the broadcast head end server 108 and the STB 124 because commercial downloads are not required during every commercial segment. Additionally, the commercials in the commercial store 224 that are associated with a recorded program 262 may be updated. In such an embodiment, the memory location of the commercial formerly associated with a given commercial segment in a recorded program 232 is used to store the new commercial segment and a link or pointer from the recorded program 232 may simply identify the memory location of the commercial rather than the commercial itself. Accordingly, the commercial may be updated a number of times while a recorded program 232 resides on the memory 216 and no changes to the recorded program 232 are required.

The memory 216 may also include a commercial optimization agent 240. The commercial optimization agent 240 may be used to locally monitor the presentation of live programs and/or recorded programs 232. While monitoring the programs, the optimization agent 240 may determine when to insert a locally stored commercial into a commercial segment thereby optimizing the commercial segment to the end user. Alternatively, the commercial optimization agent 240 may report that a commercial segment is being played or is about to be played to the broadcast head end server 108, where the commercial optimization agent 112 at the broadcast head end server 108 is able to retrieve the proper commercial from the commercial database 120 and transmit it as a part of the broadcast to the reporting STB 124.

The STB 124 is operable to communicate with the broadcast head end server 108 via the network transceiver 208. The network transceiver 208 may comprise a coaxial cable connection, a USB port or other type of serial port, a modem, an Ethernet adapter, a satellite adapter, or the like. Content received at the network transceiver 208 is communicated to the processor 204 and/or the memory 216. Content that may be transmitted to the STB 124 includes, but is not limited to, live broadcasts from cable, satellite, or radio waves, songs, application data, application results, recorded video and static images, computer rendered images, specialized advertisements, triggers, and the like. The transceiver 208 may also be used to transmit data to the broadcast head end server 108.

The user interface 212 may comprise a receiver for communicating with a viewer/user control interface 248 such as a conventional wired or wireless TV remote control, a universal remote control, or the like. The user interface 212 may include an infrared (IR) receiver for receiving signals from an IR controller. The user interface 212 may also comprise a keyboard, mouse, or other type of direct user input. A user may employ the viewer control interface 248 to interact with interactive content and/or to navigate other types of content presented to the user. The viewer control interface 248 may include a select button 252 that can be used to select a trigger to engage in interactive content as well as arrow buttons 256 that can be utilized to navigate interactive content and chose between a number of presented triggers. The viewer control interface 248 may further include a resume button 260 that allows the user to navigate back to the previous screen without engaging a particular trigger.

The display device interface 244 provides the STB 124 the ability to communicate with the display apparatus 128. The display device interface 244 may include wired or wireless communication equipment. For example, the display device interface 244 may comprise a USB port or video jack. Alternatively, the display device interface 244 may comprise an RF transceiver for transmitting/receiving RF signals to/from the display apparatus 128.

In accordance with one embodiment of the present invention, commercials and recorded programs 232 are stored in the memory 216 when they are received at the network transceiver 208. The content is typically stored in a particular address of the memory 216 such that it can be easily retrieved at a later time. In accordance with at least one embodiment, commercial updates are sent to the STB 124 during idle periods (i.e., when the user is not viewing a live broadcast). However, commercials can also be sent to the STB 124 during a live broadcast through one or more VBIs as packets of information that can be stored in memory 216 while the live broadcast is being displayed. The packets of information can then be stored in memory 216 (e.g., a buffer memory) and reconstructed by the processor 204.

As noted above, the commercials maintained in the commercial store 224 may include interactive applications and/or interactive advertisements that are access by a trigger. A trigger usually contains an address, pointer, or some other sort of reference to the stored content or a live broadcast. When a user activates a trigger during a broadcast, the processor 204 utilizes the address of stored content associated with the trigger to retrieve the content from memory 216 or from the broadcast head end server 108. In the event that the content associated with the trigger is a live broadcast, then the trigger references the channel where the live broadcast can be found. Subsequently, the content can be displayed to a user via the display apparatus 128. Thus, multiple pre-stored contents can be maintained in the memory 216 for later display at the appropriate time or a user can navigate multiple live contents via triggers.

Generally, a trigger is transmitted along with a broadcast and both are displayed to a user via the display apparatus 128. A user is able to select the displayed trigger via the user interface 212. The processor 204 registers the request, determines the address of the stored commercial in memory 216, and retrieves the associated commercial from the memory 216. Alternatively, the processor 204 registers the request and determines the address of the live broadcast content on another channel. Thereafter, the requested commercial is transmitted to the display apparatus 128 for presentation to the user.

Selection of a trigger may also indicate that the content displayed on the display apparatus 128 is to be altered. In other words, engagement of a trigger may indicate that the display is to be altered to incorporate at least two different images, each associated with a different content or commercial. For instance, if a trigger is selected the presentation of the program (i.e., either a live or recorded program 232) may be supplemented with the presentation of the commercial chosen to optimize the commercial segment. Accordingly, two different commercials may be displayed to a user simultaneously, where one is the commercial originally inserted into the program and the other is a commercial optimized and selected for the specific viewer associated with the STB 124.

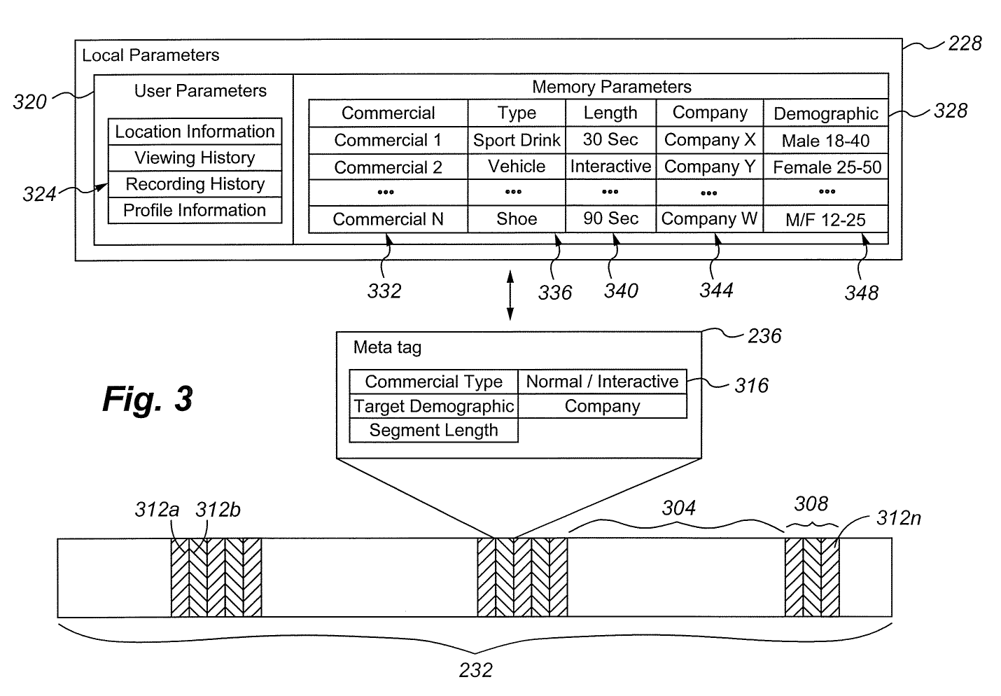

FIG. 3 depicts time-block view of a program, such as a live program or recorded program 232, in accordance with at least some embodiments of the present invention. A program broadcast across the transmission network 104 may generally include program content as well as commercial content. The duration of the program 304 may therefore be comprised of show segments 304 as well as commercial segments 308, also known as commercial breaks to those skilled in the art. The show segments 304 may contain the content of the show currently being broadcast whereas the commercial segments 308 may include a plurality of sub-segments 312a-N. Each commercial sub-segment 312 may be filled with a commercial or commercial space for a different product/service or different commercials for the same product/service. The total program is generally configured to include commercial segments 308 that separate the show segments 304.

The beginning and end of each sub-segment 312 may be defined by time markers or specific times measured relative to the beginning or ending of the program. For a recorded program 232, the beginning and end may alternatively be identified based on when the program started recording. On the other hand, the program may be transmitted with triggers or flags that identify when a commercial segment 308 or sub-segment 312 begins or is about to begin. The placement of a trigger or flag a few milliseconds before the commercial segment 308, 312 begins allows the processor 204 to utilize the commercial optimization agent 240 to determine if the upcoming segment 308, 312 should be optimized with a commercial stored in the commercial store 224. In accordance with at least one embodiment of the present invention, the time between the flag and the actual beginning of the segment only needs to be long enough to allow the optimization decision to be made, that is time does riot need to be added to download the commercial from the broadcast head end server 108. In such an embodiment, the optimization decision is based on locally available commercials.

In accordance with at least one alternative embodiment of the present invention, the flag may be placed further before the beginning of the upcoming segment 308, 312 to allow for the downloading of a commercial from the broadcast head end 108. However, in this embodiment the size (in bytes) of the commercial itself may need to be factored into the commercial selection decision because certain commercials (e.g., high definition commercials) may take too long to download before they are presented. In still another alternative embodiment of the present invention, the commercial may be downloaded to a buffer and displayed from that buffer such that only part of the commercial has to be downloaded before presentation of the commercial begins, as long as the commercial is completely downloaded prior to the end of the commercial segment.

To facilitate the commercial optimization agent 112, 240 in selecting a commercial for presentation during a particular segment, data from a segment meta tag 236 may be compared with local parameters 228. As can be seen in FIG. 3, the meta tag 236 may comprise various information 316 related to the commercial segment such as the commercial type intended for the commercial segment, the target demographic, the segment length, whether a normal or interactive commercial is to be presented during the segment, and what company purchased the segment. If there is no preference or data defined for a certain field, then that particular field may be left empty.

Although the meta tag 236 is depicted as describing the desired characteristics of a given sub-segment 312, additional meta tags 236 may be provided that define desired characteristics for a particular commercial break or segment 308. A meta tag 236 for the segment 308 may define rules regarding what types of commercials are placed sequentially. For instance, data in a meta tag 236 of a segment 308 may define that back-to-back segments cannot have the commercials directed toward the same product or from the same company. Alternatively, the meta tag 236 may define that a certain company cannot have its commercial immediately precede or succeed another company's commercial. The meta tag 236 of the segment 308 may further define that a certain number of commercials from a given company have to be assigned to that segment 308. Various other rules related to the overall assignment of commercials in sub-segments 312 may be outlined by the meta tag 236 associated with the segment 308. As can be appreciated by one skilled in the art, a meta tag 236 may be associated with an entire live program or recorded program 232 defining how many commercials of a certain type or from a certain company are required.

The commercial optimization agent 112, 240 may be operable to compare the local parameters 228 to one or more meta tags 236 of a program. By comparing the local parameters 228 to the data from a meta tag 236, the commercial optimization agent 112, 240 may assign commercials to segments 308 and/or sub-segments 312 to target the commercials presented to the end viewer. In accordance with at least some embodiments of the present invention, the local parameters 228 may comprise user parameters 320 and memory parameters 328. The user parameters 320 may comprise various data fields 324 for storing data specific to the user or viewer associated with the STB 124. The user parameters 320 may comprise data for a number of viewers if there are a plurality of viewers associated with the same STB 124. The user parameter fields 324 may include, but are not limited to, location information for the STB 124, user viewing history, user recording history, and profile information. The location information, viewing history, and recording history may be determined without user assistance by simply monitoring various user activities. For example, the types of shows that the user views may indicate general viewing preferences for the user while recording history may indicate more accurate viewing preferences. Therefore, when comparing user parameters 320 to data from the meta tag 236, the commercial optimization agent 112, 240 may apply a greater weight to recording history than viewing history.

In addition to passively retrieved user parameters fields 324, the user may elect to provide additional information that can be stored as user profile information. The user profile information may define the user's hobbies, tastes, and preferences. This particular information may be given more weight than passively retrieved user parameters 320 when optimizing a given segment 308, 312.

The memory parameters 328 may comprise data related locally available commercials. In accordance with one embodiment of the present invention, the memory parameters 328 may contain description data for commercials stored in the commercial store 224. The locally available commercials are those commercials that do not require a great amount of time to access and display during a commercial segment 308, 312. The data used to define such commercials may be stored in, for example, a commercial identifier field 332, a commercial type field 336, a commercial length field 340, a company field 344, and a demographic field 348. The data stored in the commercial type field 336 may describe they type of product and/or service that is being advertised in the subject commercial. Data from the length field 340 may describe not only the length of the commercial but whether the commercial is interactive or not. Data in the company field 344 may describe the company that is affiliated with the subject commercial. There may of course be multiple companies affiliated with a single commercial. Data stored in the demographic field 348 may describe what the preferred target demographic is for a given commercial. Demographics may be defined based on gender, age, occupation, hobbies, and so on.

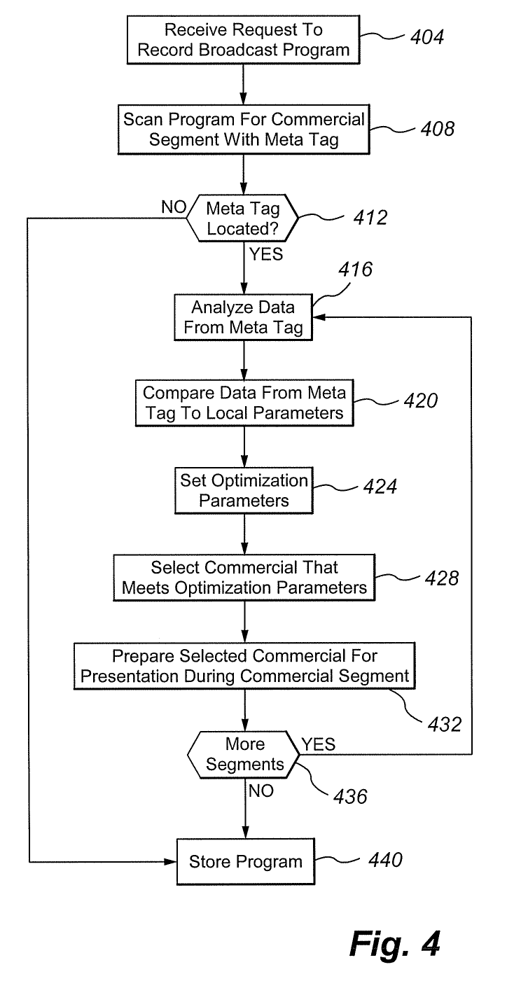

FIG. 4 is a flow diagram depicting a method of optimizing a recorded program 232 in accordance with at least some embodiments of the present invention. Although described in association with a recorded program 232, one skilled in the art will appreciate that certain optimization steps described herein can be applied with equal effectiveness to live programs. The method begins when a request to record a broadcast program is received (step 404). The request may be received from a user viewing the live broadcast of the program. Alternatively, the user may have pre-defined certain programs that are to be recorded when they are broadcast. In such an embodiment, the request to record the program may be automatically generated.

Upon receiving the request to record the program, the commercial optimization agent 112, 240 scans the program for meta tags 236 (step 408). The meta tags 236 may be located in association with a total program, a commercial segment 308, and/or a commercial sub-segment 212. In step 412, it is determined if a meta tag 236 has been located. In the event that the program has no meta tags 236, then the commercial optimization agent 112, 240 does not have the information necessary to optimize the program and accordingly allows the recorded program 232 to be stored without such optimization (step 440).

On the other hand, if at least one meta tag 236 is located, then the commercial optimization agent 112, 240 will analyze the data from the meta tag 236 (step 416). During the analysis of the meta tag 236, the commercial optimization agent 112, 240 may determine certain restrictions that have been applied to segment associated with the meta tag 236. The restrictions may help the commercial optimization agent 112, 240 determine what commercial can be assigned to the given segment. Furthermore, the analysis of the meta tag 236 may reveal certain characteristics of a commercial that are desired for the commercial segment. Examples of data that can be evaluated during the analysis of the meta tag 236 include, but are not limited to, commercial type, target demographic, segment length, normal/interactive, and company. The data in the meta tag 236 may define either commercial requirements or preferences. For example, data related to commercial type may be viewed as a preference whereas data related to a company or segment length may be a requirement for the commercial segment.

After the commercial optimization agent 240 has analyzed the meta tag 236, the commercial optimization agent 240 compares data from the meta tag 236 to the local parameters 228 (step 420). As a first step of comparison the commercial optimization agent 240 may compare the data from the meta tag 236 to the user parameters 320 to determine what type of commercial would best suit the viewer associated with the STB 124. Then, as a second step of comparison the meta tag 236 to the memory parameters 328 to determine which locally available commercial best meets the requirements and preferences of the meta tag 236. Alternatively, the order of comparisons may be reversed. That is, the commercial optimization agent 240 may first compare data from the meta tag 236 to the memory parameters 328 then to the user parameters 320. Still further in the alternative, the data from the meta tag 236 may be simultaneously compared to the memory parameters 328 and the user parameters 320.

As a result of comparing the local parameters 228 to the meta tag 236 data, the commercial optimization agent 112, 240 is operable to set optimization parameters for the segment (step 424). The optimization parameters outline what commercials are best suited for the segment associated with the meta tag 236 based on the requirements and preferences defined by the meta tag 236 as compared to available commercials. More specifically, the optimization parameters may outline what commercial features best meet the definitions contained within the meta tag 236. As a part of setting optimization parameters, the commercial optimization agent 112, 240 may also order or rank the locally available commercials based on their adherence to the optimization parameters.

Once the optimization parameters have been defined, the commercial optimization agent 112, 240 continues by selecting the commercial that best meets the optimization parameters (step 428). In accordance with one embodiment of the present invention, the selected commercial is a locally available commercial. In accordance with an alternative embodiment, the selected commercial may reside in the commercial database 120.

The commercial optimization agent 112, 240 then prepares the selected commercial for presentation during the commercial segment associated with the meta tag 236 (step 432). The preparation of the commercial may include identifying the memory address where the commercial is stored and creating a link between the segment and the memory address such that when the segment is played (i.e., either as part of a live broadcast or during replay of a recorded program 232) the link causes the commercial to be played during the segment. The commercial may be presented instead of or in addition to the originally broadcast commercial. Alternatively, the preparation of the commercial may include inserting the selected commercial into the associated segment.

In an embodiment where the selected commercial is locally available to the STB 124, the commercial may be prepared for presentation immediately. In embodiments where the commercial is not locally available, the STB 124 may download the commercial or if the commercial is selected prior to transmission of the program across the transmission network 104, the broadcast head end server 108 may insert the commercial into the segment.

After the selected commercial has been prepared for presentation during the segment associated with the first identified meta tag 236, the method continues by determining if more segments exist within the program (step 436). This query may be answered affirmatively if the original scan for meta tags 236 indicated that more than one meta tags 236 were resident within the recorded program 232 or if the user is still watching a live program. In the event that there is more meta tags 236, the method returns to step 416 where data from the next meta tag 236 is analyzed by the commercial optimization agent 112, 240. Alternatively, if there are no further meta tags 236 in the program, then the method continues by storing the program as a recorded program 232 (step 440). When the recorded program 232 is stored in memory 216, the links may be maintained between various segments characterized as having a meta tag 236 and the associated commercials selected for optimization of that segment.

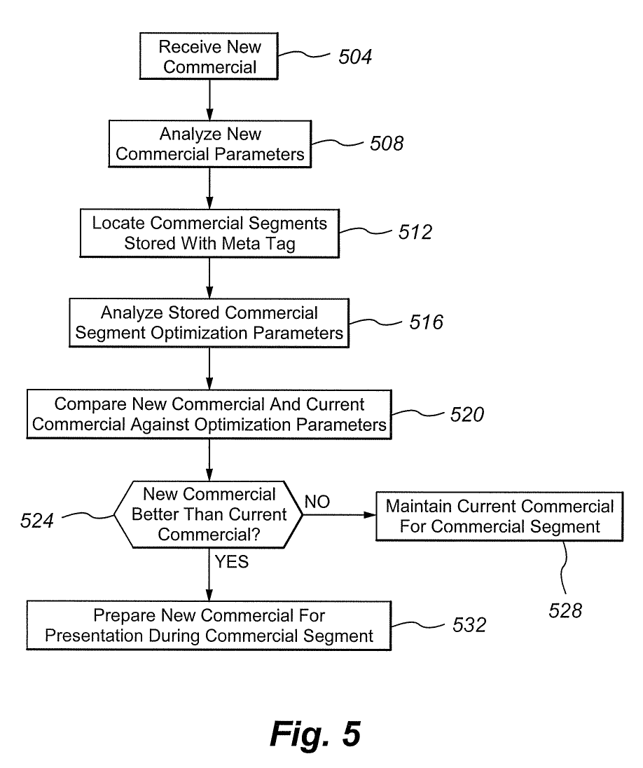

Referring now to FIG. 5, a method of optimizing a recorded program 232 with an updated commercial will be described in accordance with at least some embodiments of the present invention. The method is initiated when a new commercial is received at a STB 124 (step 504). The new commercial may be received as a result of the STB 124 requesting a new commercial or as a result of the broadcast head end server 108 unilaterally transferring the commercial to the STB 124.

Upon receiving the new commercial, the commercial optimization agent 112, 240 analyzes the parameters of the new commercial (step 508). More specifically, the commercial optimization agent 112, 240 identifies the various characteristics of the new commercial such as, what the commercial is for, what company the commercial is for whether the commercial is interactive or not, the length of the commercial, and the target demographic of the commercial. After the characteristics of the new commercial are determined, data for the new commercial can be input into the various fields of the memory parameters 328, at which point the new commercial may be regarded as locally available.

Once the new commercial parameters have been analyzed, the commercial optimization agent 112, 240 locates all recorded programs 232 having commercial segments with a meta tag 236 associated therewith (step 512). The commercial optimization agent 112, 240 then analyzes each stored commercial segment's optimization parameters (step 516). In accordance with one embodiment, when a commercial segment is located having a meta tag 236 associated therewith, the commercial optimization agent 112, 240 then analyzes the optimization parameters for that commercial segment before searching for another commercial segment. In another embodiment, the commercial optimization agent 112, 240 locates all commercial segments before analyzing the optimization parameters of commercial segments.

When the optimization parameters for one or all commercial segments have been analyzed, the commercial optimization agent 112, 240 compares the optimization parameters of each segment against both the new commercial parameters and the currently assigned commercial parameters (step 520). In this step, the commercial optimization agent 112, 240 first determines how well the currently assigned commercial parameters match the optimization parameters then determines how well the new commercial parameters match the optimization parameters. The new commercial parameters are compared against optimization parameters of each commercial segment having a meta tag 236. Thereafter, the commercial optimization agent 112, 240 determines whether the new commercial better satisfies the optimization parameters than the currently assigned commercial (step 524). This step is performed individually for each commercial segment. Of course, if the new commercial was downloaded to replace a specific commercial, then no comparison may be necessary. Rather, the new commercial may be assigned to the commercial segment that was previously associated with the now replaced commercial.

If comparison is necessary and the new commercial parameters do not meet the optimization parameters of any segment better than the currently assigned commercial, then the currently assigned commercial maintains is association with the commercial segment (step 528). In addition to this step, the STB 124 may communicate back to the broadcast head end server 108 that the newly received commercial was not assigned to any commercial segments, in which case the broadcast head end server 108 may provide another commercial to the STB 124 to replace the other commercial.

Conversely, in the event that the new commercial parameters meet the optimization parameters of at least one commercial segment better than the currently assigned commercial, then the new commercial is prepared for presentation during the subject commercial segment (step 532). In other words, the commercial segment is linked to the new commercial and the link with the older commercial is broken. This essentially causes the new commercial to replace the older commercial in the subject commercial segment.

If the new commercial is determined to be better for only one commercial segment then the new commercial can be assigned to that segment. However, in the event that the new commercial is a better match to a plurality of commercial segments, then the commercial optimization agent 112, 240 may need to analyze the meta tag 236 for the entire program and/or any other meta tags associated with the commercial segment. For instance, if the new commercial is a better fit for a particular sub-segment 312, then the commercial optimization agent 112, 240 may analyze the meta tag 236 of the segment 308 containing the sub-segment 312 as well as the meta tag 236 of the program itself. All meta tags 236 are analyzed to determine if there are any restrictions on assigning the new commercial to a given sub-segment 312. Furthermore, the commercial optimization agent 112, 240 may determine how many commercial segments the new commercial can be assigned to based on the restrictions and preferences defined in all meta tags 236. For instance, a meta tag 236 associated with a commercial segment 308 may indicate that the same commercial cannot be assigned to more than one commercial sub-segment 312 within that segment 308. Furthermore, a meta tag 236 associated with the total program may indicate that a commercial cannot be assigned to the entire program more than a predetermined number of times.

If restrictions exist that limit the number of times a commercial can be assigned within a given program, then the commercial optimization agent 112, 240 must select which commercial segments will be assigned to the new commercial. In accordance with one embodiment of the present invention, the commercial optimization agent 112, 240 may assign the new commercial to the segment having optimization parameters best met by the new commercial. In an alternative embodiment, the commercial optimization agent 112, 240 may assign the new commercial to a segment based on the difference between the matching scores of the new commercial and the currently assigned commercial. In other words, the commercial optimization agent 112, 240 may compute the matching score between the new commercial and the optimization parameters of each segment and subtract that matching score from the matching score of each assigned commercial to the same segment. Then the commercial optimization agent 112, 240 may select the new commercial for the segment or segments having the largest difference between matching scores.

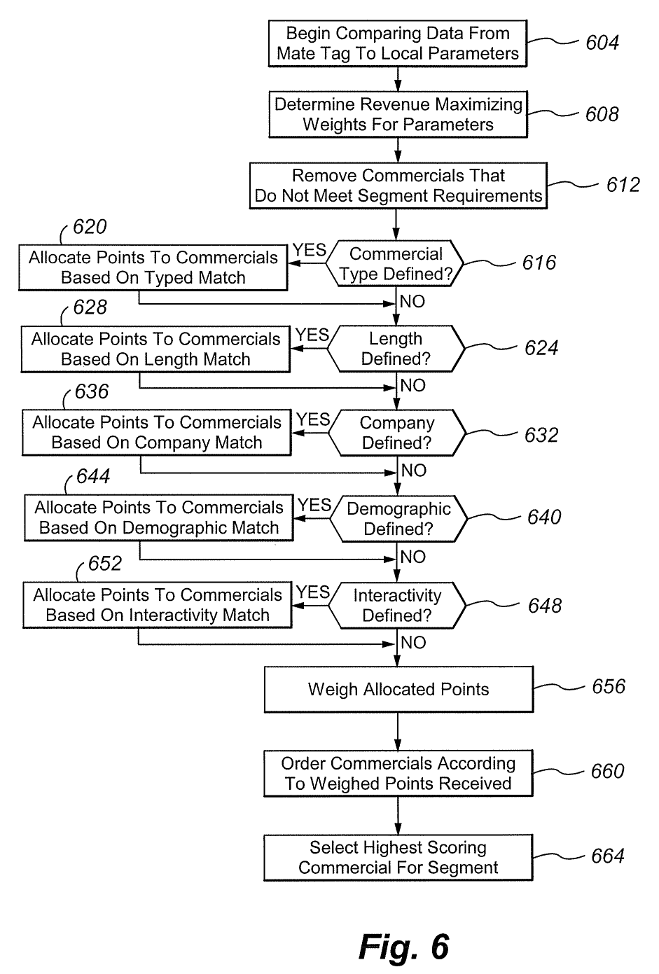

With reference to FIG. 6, a method of applying a scoring system to optimize a commercial segment will be described in accordance with at least some embodiments of the present invention. Initially, the commercial optimization agent 112, 240 compares the data from a meta tag 236 to local parameters 228 (step 604). More specifically, the commercial optimization agent 112, 240 compares the data from the meta tag 236 to the user parameters 320 and the memory parameters 328 to determine what commercials are locally available as well as to determine the optimization parameters for the commercial segment. The comparison also results in a determination of revenue maximizing (i.e., the revenue of the company paying for the commercial) weights for the parameters defined by the meta tag 236 (step 608). In accordance with one embodiment of the present invention, the revenue maximizing parameters are a part of the optimization parameters, where another part of the optimization parameters comprises the restrictions on commercial assignments. The revenue maximizing weights characterize the importance of various parameters for a given target audience and their perceived relationship to the commercial resulting in actual sales.

Once the revenue maximizing weights have been determined, the commercial optimization application 112, 240 removes all commercials from its list of candidate commercials that do not meet the segment requirements as defined by one or more meta tags 236 associated with the subject segment (step 612). For instance, the commercial optimization application 112, 240 may remove any commercial that does not have a length matching the required length. Additionally, for example, if a meta tag 236 requires an interactive commercial for a given segment, then the commercial optimization application 112, 240 may remove all non-interactive commercials. By removing the non-compliant commercials from the list of candidate commercials, the commercial optimization application 112, 240 reduces the number of commercials that need to be processed when assigning scores to commercials, which in turn reduces the time required to make an optimization decision. In accordance with at least one embodiment of the present invention, all non-locally available commercials may also be removed from the list of candidate commercials.

With the non-compliant commercials removed from the list of candidate commercials, the commercial optimization application 112, 240 determines if the meta tag 236 associated with the subject segment defines a type of commercial desired for the segment (step 616). The meta tag 236 may define a single commercial type that should be assigned to the segment or a number of types. Additionally, each commercial type may be weighted based on importance as defined by the purchaser of the segment. If a desired commercial type is defined by the meta tag 236, then the commercial optimization agent 112, 240 allocates points to each candidate commercial based on type match (step 620). A commercial having a closer type match to the desired commercial type may receive more points than other commercials having a lesser match. Alternatively, points may be allocated in a binary fashion, meaning that if a commercial has a matching commercial type, then it receives points; otherwise no points are allocated to that commercial.

After points have been assigned to the candidate commercials based on commercial type, or if commercial type was not defined by the meta tag 236, then the commercial optimization agent 112, 240 continues by determining if the meta tag 236 defines a requested length (step 624). The length of the commercial may be an exact time or a range or time. If a desired length is defined by the meta tag 236, then the commercial optimization agent 112, 240 allocates points to each candidate commercial based on length match (step 628). The allocation of points may be based on the degree to which the commercial's length matches the requested length, or based on whether the commercial's length meets the length defined by the meta tag 236.

Upon assigning points to candidate commercials based on commercial length, or if commercial length was not defined by the meta tag 236, then the commercial optimization agent 112, 240 determines if the meta tag 236 defines a company for the segment (step 632). The company defined by a meta tag 236 for a given segment may correspond to the company that purchased the commercial segment or a company that has rights to purchase the commercial segment if their commercial is assigned to that segment. If the meta tag 236 defines a company or number of companies for a given segment, then the commercial optimization agent 112, 240 assigns points to candidate commercials based on company match (step 636). If only one company is defined by the meta tag 236, then the commercials may be assigned points if they match the defined company. Alternatively, if the meta tag 236 identifies a number of companies, then the commercials may be allocated points based on which company they have a match with. Some defined companies may have a higher weight than other companies, for example because a given company has purchased more commercial space than another company, in which case points may be allocated on a weighted basis.

Once points have been assigned based on company match, or if the meta tag 236 did not define a company, then the commercial optimization agent 112, 240 determines whether the meta tag 236 has defined a preferred or target demographic (step 640). The demographic may comprise a number of factors including, without limitation, age, gender, occupation, marital status, and so on. If one or more demographic factors are defined by the meta tag 236, then the commercial optimization agent 236 allocates points to candidate commercials based on demographic match (step 644). The allocation of points may be binary based on a match or no match policy. Alternatively, the allocation of points may be scaled according to how well a particular commercial matches the defined target demographic.

When the points have been allocated based on demographic match, if at all, the commercial optimization agent 112, 240 continues by determining if the meta tag 236 defines a preference for interactivity (step 648). If interactivity, or lack thereof, is defined as a preference by the meta tag 236, then the commercial optimization agent 112, 240 allocates points to commercials based on whether their interactivity matches the preference of the meta tag 236 (step 652). If the meta tag 236 defines a preference for an interactive commercial, then all interactive candidate commercials may receive points. Alternatively, if the meta tag 236 defines a preference for a non-interactive commercial, then all non-interactive candidate commercials may receive points. Of course, there may be some commercials that comprise a normal non-interactive portion and an optional interactive portion. Such commercials may receive either partial matching points or full matching points, again depending upon the preferences defined by the meta tag 236.

After all of the possible points have been assigned to candidate commercials based on how well they match the preferences defined by the meta tag 236, the allocated points may be assigned weights based on the determined revenue maximizing weights (step 656). In one embodiment, if no revenue maximizing weights were determined, then all points are weighted equally. Alternatively, if the revenue maximizing weights define certain parameters as more important than others to the effect of maximizing revenue, then the more important parameters may receive a greater weight. For example, if the revenue maximizing parameters place a greater weight on the target demographic and interactive parameters, then all commercials that received points for matching the preferred demographics or interactivity of the meta tag 236 may have their allocated points increased by a weighted factor. In another example, if a greater weight was placed on the company, then those commercials that received points based on a company match to the meta tag 236 may receive more points.

The commercial optimization agent 112, 240 then re-orders the commercials according to their weighted points received (step 660). The commercial optimization agent 112, 240 is then able to select the highest scoring commercial for the segment (step 664). In accordance with one embodiment, the selected commercial is the commercial having the most weighted points assigned thereto. However, in other embodiments, the highest scoring commercial may be precluded from being assigned to a given segment because of other rules governing the assignment order of commercials. In such a circumstance, the next highest scoring commercial may be assigned to the segment. Of course, in such embodiments the highest scoring commercial should have been removed during step 612. However, sometimes restrictions on commercials are not known until other commercials have been assigned to another segment. Accordingly, some commercials may initially be candidates for a given segment but after some other commercials have been assigned to segments, the candidate commercial may be precluded from being assigned to that segment.

Although methods of the present invention have been described with the sequential assignment of commercials to segments, other optimization techniques known to those skilled in the art may be practiced that identify all of the rules and parameters of all meta tags 236 for a program and compare those rules with all candidate commercials at the same time. Then an optimization decision for all segments can be made simultaneously as a global optimization, thereby optimizing the commercial segments for the entire program rather than focusing on each segment in a sequential fashion.

While the above-described flowcharts have been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are riot limited to the specifically illustrated embodiments but can also be utilized with the other exemplary embodiments and each described feature is individually and separately claimable.

The systems, methods and protocols of this invention can be implemented on a special purpose computer in addition to or in place of the described STB, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and television arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems and methods for advertisement enhancement. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method of optimizing a commercial segment in a broadcast program, comprising:
receiving a program comprising at least one commercial segment, wherein the at least one commercial segment has a meta tag associated therewith;
analyzing data from the meta tag;
determining optimization parameters for the at least one commercial segment;
comparing the optimization parameters to parameters of commercials from a set of locally available commercials;
determining that parameters of a first commercial meet the optimization parameters as well as or better than parameters of other commercials in the set of locally available commercials; and
selecting the first commercial for presentation during the at least one commercial segment.

2. The method of claim 1, further comprising:
receiving a request to record the received program;
storing the received program and the meta tag in memory; and
linking the at least one commercial segment with the first commercial such that upon presentation of the program from memory, the first commercial is presented during the at least one commercial segment.

3. The method of claim 2, further comprising:
receiving a second commercial;
comparing the optimization parameters to parameters of the second commercial;
determining that parameters of the second commercial meet the optimization parameters as well as or better than parameters of the first commercial; and
replacing the first commercial with the second commercial such that upon presentation of the program from memory, the second commercial is presented during the at least one commercial segment.

4. The method of claim 3, wherein replacing the first commercial comprises storing the second commercial in a memory location previously used to store the first commercial.

5. The method of claim 3, wherein replacing the first commercial comprises removing the link between the first commercial and the at least one commercial segment and creating a new link between the second commercial and the at least one commercial segment.

6. The method of claim 1, wherein the data from the meta tag comprises at least one of requirements and preferences for at least one of a commercial type, a target demographic, a commercial length, a company, and a level of interactivity for the at least one commercial segment.

7. The method of claim 1, wherein the at least one commercial segment comprises a commercial block and wherein data from the meta tag comprises requirements related to assignments of commercials to sub-segments within the commercial block.

8. The method of claim 1, wherein the at least one commercial segment comprises a plurality of commercial blocks and wherein data from the meta tag comprises requirements related to assignments of commercials to at least one of commercial blocks and sub-segments within the commercial blocks.

9. The method of claim 1, wherein the at least one commercial segment comprises a commercial block having a plurality of commercial sub-segments, wherein the commercial block comprises a first meta tag and wherein at least one of the commercial sub-segments comprise a second meta tag.

10. The method of claim 1, further comprising comparing data from the meta tag to local parameters, wherein local parameters comprise at least one of user parameters and parameters of commercials from the set of locally available commercials.

11. The method of claim 1, wherein the optimization parameters comprise at least one of commercial assignment restrictions and commercial assignment preferences.

12. The method of claim 11, further comprising:
assigning each commercial in the set of locally available commercials points for each optimization preference parameter that is met by the commercial;
weighing the points assigned to each commercial based on a perceived importance of the met optimization preference; and
determining that the first commercial received the most weighted points.

13. A computer readable medium comprising processor executable instructions for performing the method of claim 1.

14. An apparatus for optimizing a commercial segment in a broadcast program, comprising:
a receiver adapted to receive broadcast signals from a transmission network, wherein the broadcast signals comprise data related a program having at least one commercial segment with a meta tag associated therewith;
a plurality of locally available commercials; and
a commercial optimization agent adapted to select a first commercial from the plurality of locally available commercials for presentation during the at least one commercial segment, wherein the first commercial comprises characteristics that meet parameters of the meta tag better than other commercials in the plurality of locally available commercials.

15. The apparatus of claim 14, wherein the parameters of the meta tag comprise at least one of requirements for the commercial segment and preferences for the commercial segment

16. The apparatus of claim 14, further comprising a memory location operable to store the program and meta tag, wherein the commercial optimization agent is further adapted to link the first commercial to the at least one commercial segment such that during presentation of the program from memory, the first commercial is presented during the at least one commercial segment.

17. The apparatus of claim 14, further comprising presenting the first commercial during a live television broadcast of the at least one commercial segment.

18. The apparatus of claim 14, wherein the plurality of locally available commercials comprise commercials that are maintained in local memory prior to receiving the program.

19. The apparatus of claim 14, wherein upon receiving a second commercial that was not originally included in the plurality of locally available commercials the commercial optimization agent is further adapted to replace the first commercial with the second commercial in the event that the second commercial better meets parameters of the meta tag.

20. The apparatus of claim 14, wherein the first commercial comprises a commercial block having a plurality of commercial sub-segments, wherein the commercial block comprises a first meta tag and wherein at least one of the commercial sub-segments comprise a second meta tag.

21. A system for optimizing commercial segments of a broadcast program, comprising:
means for receiving a program broadcast across a transmission network;
means for analyzing data from a meta tag associated with a commercial segment contained within the program;
a plurality of locally available commercials; and
means for selecting a first commercial from the plurality of locally available commercials for presentation during the commercial segment, wherein the first commercial comprises parameters that match parameters of the meta tag better than other commercials in the plurality of locally available commercials.

22. The system of claim 20, further comprising means for recording the program.

23. The system of claim 21, wherein the means for receiving is further operable to receive a second commercial at a point in time after the program has been recorded.

24. The system of claim 22, wherein the means for selecting is further operable to replace the first commercial with the second commercial for presentation during the commercial segment.

25. The method of claim 23, wherein the first commercial is displayed to a viewer during a presentation of the commercial segment prior to the point in time that the second commercial is received and the second commercial is displayed to the viewer during a presentation of the commercial segment after the point in time that the second commercial is received.
